(19) United States
(12) Patent Application Publication
(10) Pub. No.: US 2016/0039610 A1
(43) Pub. Date: Feb. 11, 2016

(54) Fiber Reinforcement Layer for Conveyor Belts

(71) Applicant: THE YOKOHAMA RUBBER CO., LTD., Tokyo (JP)

(72) Inventor: Hiroko Okuno, Hiratsuka-shi, Kanagawa (JP)

(73) Assignee: The Yokohama Rubber Co., Ltd., Minato-ku, Tokyo (JP)

(21) Appl. No.: 14/782,579

(22) PCT Filed: Apr. 3, 2014
(86) PCT No.: PCT/JP2014/059824

§ 371 Date: Oct. 5, 2015

(30) Foreign Application Priority Data
Apr. 5, 2013 (JP) 2013-079080

(51) Int. Cl. B65G 15/34

(52) U.S. Cl. CPC B65G 15/34

(57) ABSTRACT

Provided is a fiber reinforcement layer for conveyor belts. Warp threads and weft threads of a fiber reinforcement layer embedded in a conveyor belt are formed from polyester fibers, the weft threads are single-twist threads in which one more multiple filaments are arranged and twisted in a single direction, twist count is from 8 to 10 (twists/10 cm) if the linear mass density of the weft threads is at least 840 dtex but less than 2,200 dtex, from 7 to 8 (twists/10 cm) if the linear mass density is at least 2,200 dtex but less than 4,400 dtex, and from 6 to 7 (twists/10 cm) if the linear mass density is at least 4,400 dtex but less than 6,700 dtex.

TECHNICAL FIELD The present technology relates to a fiber reinforcement layer for conveyor belts, and more specifically to a woven fiber reinforcement layer for conveyor belts that allows for improved quality of appearance and productivity despite polyester fibers being used for the weft threads thereof.

### BACKGROUND

Single or multiple fiber reinforcement layers having plain- or other types of woven structures are generally used as tension-bearing cores in conveyor belts, and various arrangements have been proposed for such fiber reinforcement layers (see, for example, Japanese Unexamined Patent Application Publication No. S62-62910). Polyester fibers are widely used as the warp threads in fiber reinforcement layers, and nylon 66 fibers as the weft threads. During the process of manufacturing a conveyor belt, the fiber reinforcement layer is dipped in a liquid adhesive, then heat-treated (see, for example, Japanese Unexamined Patent Application Publication No. 2011-126651A). During heat treatment, the warp threads are in a tensed state, but substantially no tension is placed upon the weft threads. For this reason, weft threads made of nylon 66 fibers readily exhibit thermal contraction; in order to prevent this, polyester fibers, which exhibit less thermal contraction, may also be used. Polyester fibers, which are less expensive than nylon 66 fibers, may also be used in order to reduce costs.

However, when polyester fibers are used for the weft threads, untwisting readily occurs, as illustrated in FIG. 4, when no or little tension is placed thereupon due to the higher rigidity, etc. of the fibers compared to nylon 66 fibers. This results in the problem that, because of the low amount of tension placed upon the weft threads during weaving, untwisted weft threads are woven into the fabric, creating kinks (lumps) that flaw appearance. The occurrence of such flaws in appearance occur necessitates mending of the woven fiber reinforcement layer, drastically reducing productivity. In addition, sections where kinks have formed more readily absorb the liquid adhesive than do normal sections when the fiber reinforcement layer is dipped in the liquid adhesive, resulting in problems such as insufficient drying or dark discoloration during the heat treatment process.

### SUMMARY

The present technology provides a fiber reinforcement layer for conveyor belts that allows for improved quality of appearance and productivity despite polyester fibers being used for the weft threads thereof.

A fiber reinforcement layer for conveyor belts according to the present technology is a woven fiber reinforcement layer for conveyor belts in which warp threads and weft threads are formed from polyester fibers, the layer being characterized in that the weft threads are single-twist threads in which one or multiple filaments are arranged and twisted in a single direction, and twist count T is set according to linear mass density D per single weft thread as follows:
if 840 dtex≦D<2200 dtex, then T is from 8 to 10 (twists/10 cm);
if 2200 dtex≦D<4400 dtex, then T is from 7 to 8 (twists/10 cm); and
if 4400 dtex ≦D<6700 dtex, then T is from 6 to 7 (twists/10 cm).

In accordance with the present technology, a suitable twist count T is set for the weft threads according to the linear mass density D, thereby inhibiting the occurrence of untwisting. This is advantageous in improving the quality of appearance and productivity of the fiber reinforcement layer. Too low a twist count T prevents the smooth passage of the weft threads from one widthwise end of the fiber reinforcement layer to the other during weaving, facilitating weft thread fuzz formation. However, in the present technology, the twist count T is set within the ranges described above, which allow for smooth passage of the weft threads during weaving, thereby inhibiting fuzz formation. This feature also yields superior quality of appearance for the fiber reinforcement layer.

Focusing on the relationship between the linear mass density D and the twist count T of the weft threads in this way allows for improved quality of appearance and productivity despite the use of polyester fibers for the weft threads.

The fiber reinforcement layer of the present technology is, for example, a plain weave.

### BRIEF DESCRIPTION OF THE DRAWING(S)

FIG. 1 is a cross-sectional view illustrating a conveyor belt in which a fiber reinforcement layer for conveyor belts according to the present technology is embedded.

FIG. 2 is a partially cut-out perspective view illustrating the conveyor belt of FIG. 1.

FIG. 3 is an explanatory illustration illustrating a process of twisting to form a weft thread.

FIG. 4 is an explanatory illustration illustrating untwisting in a weft thread.

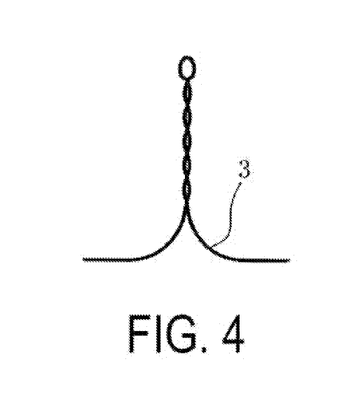

### DETAILED DESCRIPTION

The fiber reinforcement layer for conveyor belts according to the present technology will now be described on the basis of the embodiment illustrated in the drawings.

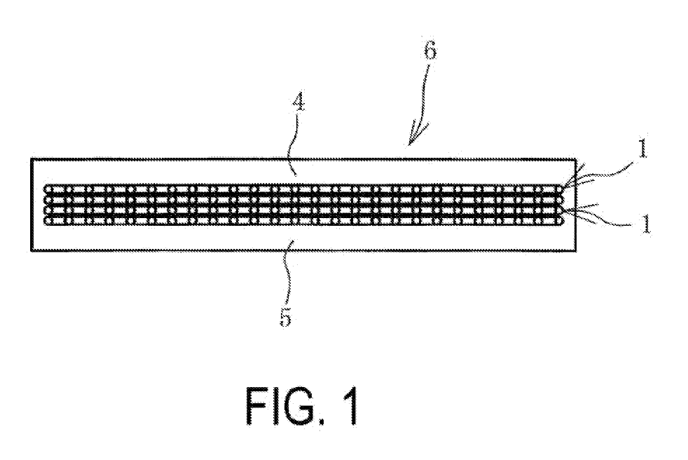

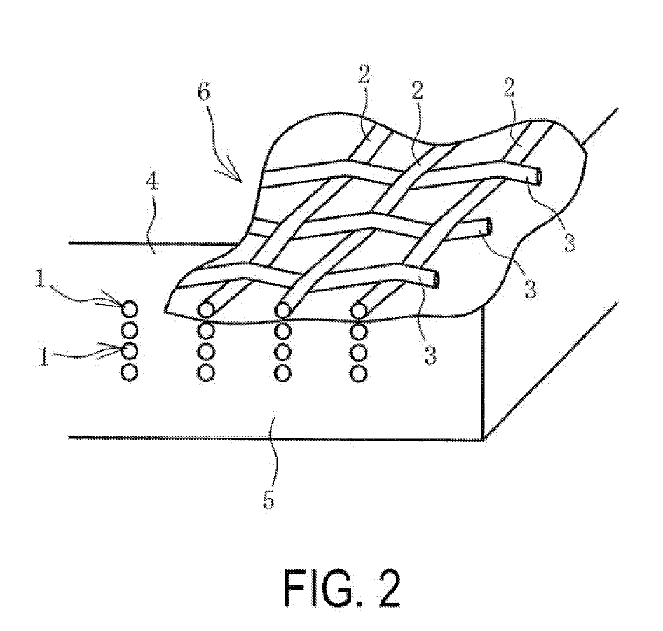

Fiber reinforcement layers 1 for conveyor belts (hereafter referred to as “fiber reinforcement layers 1”) according to the present technology illustrated in FIGS. 1 and 2 are embedded in a conveyor belt 6 between an upper rubber layer 4 and a lower rubber layer 5 as tension-bearing cores. The number of fiber reinforcement layers 1 is determined by the properties (rigidity, elongation, etc.) required of the conveyor belt 6, and is not limited to four layers as in the present embodiment, with one layer or a different number of layers also being acceptable.

All of the fiber reinforcement layers 1 are identically configured as plain weaves comprising warp threads 2 that extend in the longitudinal direction of the belt and weft threads 3 that extend in the widthwise direction of the belt, the warp and weft threads alternately passing over and under each other. The weft density of the weft threads 3 is set to a relatively low value of, for example, from 5 to 15 threads/cm. For this reason, the use of these fiber reinforcement layers 1 contributes to a reduction in the horizontal rigidity of the conveyor belt 6, thereby facilitating deformation so as to conform to the carrier rolls in the case of a pipe conveyor belt and to deformation so as to conform to the guide pipes holding the outer sides of the belt in the case of an air-supported conveyor belt.

The fiber reinforcement layers 1 of the embodiment are plain-woven; examples of other weaves include twill weaves and semi-matte weaves. If especially high tensile strength is required of the fiber reinforcement layers 1, a semi-matte weave is used; if ordinary tensile strength is sufficient, a plain weave is used. The fiber reinforcement layers 1 are formed by weaving the warp threads 2 and the weft threads 3 using, for example, a rapier loom.

During the process of manufacturing the conveyor belt 6, the fiber reinforcement layers 1 are dipped in a liquid adhesive, then heat-treated. The fiber reinforcement layers 1 are then sandwiched between the upper rubber layer 4 and the lower rubber layer 5 to form an unvulcanized molded article (conveyor belt), which is vulcanized in the mold to produce the conveyor belt 6.

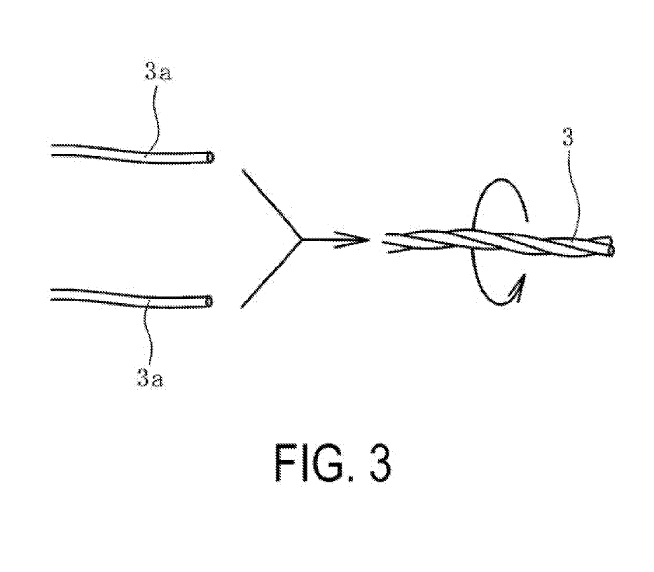

The warp threads 2 and weft threads 3 are formed from polyester fibers. In the present embodiment, the weft threads 3 are single-twist threads in which multiple filaments 3a are arranged and twisted in a single direction, as illustrated in FIG. 3. The weft threads 3 of the present technology are single-twist threads in which one or multiple filaments 3a are arranged and twisted in a single direction.

The twist count T of the weft threads 3 is set according to the linear mass density D per single weft thread 3. Specifically, the twist count T is from 8 to 10 (twists/10 cm) if the linear mass density D is at least 840 dtex (decitex) but less than 2,200 dtex, from 7 to 8 (twists/10 cm) if the linear mass density D is at least 2,200 dtex but less than 4,400 dtex, and from 6 to 7 (twists/10 cm) if the linear mass density D is at least 4,400 dtex but less than 6,700 dtex. In other words, the twist count T decreases within a prescribed range as the linear mass density D increases. If the linear mass density D is 6,700 dtex or higher, the twist count T is set, for example, to from 5 to 6 (twists/10 cm).

Unlike the warp threads 2, substantially no tension is placed upon the weft threads 3 during the process of weaving the fiber reinforcement layers 1. For this reason, untwisting of the weft threads 3 will more readily occur if polyester fibers are used for the weft threads 3 and the twist count T is too great, and kinks (lumps) will frequently occur if the weft threads 3 are used in weaving in their untwisted state, thereby creating flaws in appearance. The occurrence of such flaws in appearance creates the need for mending, drastically reducing productivity.

However, in the present technology, the twist count T is set within a range based upon the linear mass density D per one weft thread 3 so as not to be excessive, thereby preventing untwisting of the weft threads 3. This prevents flaws in appearance from occurring during weaving, providing a great advantage in improving the productivity of the fiber reinforcement layers 1.

Sections of the weft threads 3 where kinks have formed more readily absorb the liquid adhesive than do normal sections when the fiber reinforcement layer 1 is dipped in the liquid adhesive. For this reason, problems such as insufficient drying or dark discoloration occur in those sections of the weft threads 3 in which kinks occur during the heat treatment process performed during the process of manufacturing the conveyor belt 6. However, untwisting of the weft threads 3 is impeded and kinks are prevented in the present technology, offering an advantage in avoiding such problems.

If the twist count T of the weft threads 3 is too low, there will be difficulty in smoothly passing the weft threads 3 from one widthwise side of the fiber reinforcement layers 1 to the other when weaving the fiber reinforcement layers 1 using a rapier loom. In this case, the weft threads 3 will interfere with the warp threads 2, causing fuzz formation and creating flaws in the appearance of the woven fiber reinforcement layers 1. Such fuzz formation reduces the tensile strength of the weft threads 3.

However, in the present technology, the twist count T is set within a range based on the linear mass density D per one weft thread 3 so as not to be excessive, thereby preventing fuzz formation on the part of the weft threads 3. This is more advantageous in improving the quality of appearance of the fiber reinforcement layers 1.

Focusing on the relationship between the linear mass density D per single weft thread 3 and the twist count T of the weft threads 3 in this way allows for improved quality of appearance and productivity despite the use of polyester fibers for the weft threads 3.

Whereas the width of the fiber reinforcement layers will decrease due to thermal shrinkage if the weft threads are of conventional nylon 66, thus requiring that the width of the fiber reinforcement layers prior to heat treatment be greater than the width of the fiber reinforcement layers following heat treatment, there is no need for the width of the fiber reinforcement layers 1 to be greater prior to heat treatment in the present technology, allowing the cord volume to be reduced and yielding significant cost reduction effects. In addition, the weave is less subject to width-constraining conditions on the part of the loom and heat treatment apparatus (dip machine), allowing for greater freedom in terms of the equipment used and for the design of a broader fabric (fiber reinforcement layer 1) than in the prior art due to the reduced thermal shrinkage.

All of the fiber reinforcement layers embedded in the conveyor belt 6 may be fiber reinforcement layers 1 according to the present technology, or only some of the layers can be fiber reinforcement layers 1 according to the present technology. For instance, a fiber reinforcement layer 1 according to the present technology can be used for only the innermost fiber reinforcement layer, or for at least the innermost fiber reinforcement layer embedded in the conveyor belt 6. Alternatively, a fiber reinforcement layer 1 according to the present technology can be used for only the outermost fiber reinforcement layer, or for at least the outermost fiber reinforcement layer.

### EXAMPLES

Twenty-two samples of fiber reinforcement layers (working examples 1 to 11; comparative examples 1 to 11) all constituted by plain weaves consisting of polyester fibers for both the warp threads and the weft threads and only having different linear mass density D (dtex) and twist count T (twists/10 cm) per single weft thread were produced as shown in table 1. The samples were measured for weft thread untwisting frequency and post-weaving weft thread tensile strength, as described below.

### (Untwisting Frequency)

The frequency at which untwisting occurred when no tension was placed upon the weft threads prior to sample production was measured. In table 1, out of 10 weft threads, cases in which untwisting occurred in 10% or less of the weft threads are labeled “x”, cases in which untwisting occurred in 50% or less of the weft threads are labeled “Δ”, and cases in which untwisting occurred in more than 50% or less of the weft threads are labeled “∘”.

### (Post-Weaving Tensile Strength of Weft Threads)

Weft threads were extracted from the samples and measured for tensile strength. In table 1, the tensile strength of the weft threads is indicated as an index against 100 for strength prior to weaving. The lower the value of the index is, the more the tensile strength has been reduced. There is a correlation between tensile strength and fuzz formation: the more fuzz formation occurs, the more tensile strength is reduced. Thus, the lower the value of the index is, the more fuzz formation occurs, and the more quality of appearance is degraded.

TABLE 1

| | | Linear mass | Linear mass | | | | Post-weaving |
|---|---|---|---|---|---|---|---|
| | | density D | density d of | | | | tensile |
| | | per single | individual | | | | strength of |
| | | weft thread | filaments | Twist | Twist count T | Untwisting | weft threads |
| | | (dtex) | (dtex) | count | (twists/10 cm) | frequency | (index) |
| Working | 1 | 840 | 840 | 1 | 9 | x | 100 |
| Example | 2 | 1100 | 1100 | 1 | 10 | x | 100 |
| | 3 | 1670 | 1670 | 1 | 10 | x | 100 |
| | 4 | 2200 | 1100 | 2 | 8 | x | 100 |
| | 5 | 3300 | 1100 | 3 | 8 | x | 100 |
| | 6 | 3340 | 1670 | 2 | 7 | x | 100 |
| | 7 | 4400 | 1100 | 4 | 7 | x | 100 |
| | 8 | 5010 | 1670 | 3 | 7 | x | 100 |
| | 9 | 5500 | 1100 | 5 | 6 | x | 100 |
| | 10 | 6600 | 1100 | 6 | 6 | x | 100 |
| | 11 | 6680 | 1670 | 4 | 6 | x | 100 |
| Comparative | 1 | 840 | 840 | 1 | 11 | ∘ | 100 |
| Example | 2 | 1100 | 1100 | 1 | 12 | ∘ | 100 |
| | 3 | 1100 | 1100 | 1 | 6 | x | 92 |
| | 4 | 1670 | 1670 | 1 | 7 | x | 93 |
| | 5 | 2200 | 1100 | 2 | 9 | Δ | 100 |
| | 6 | 3300 | 1100 | 3 | 10 | ∘ | 100 |
| | 7 | 3300 | 1100 | 3 | 6 | x | 91 |
| | 8 | 4400 | 1100 | 4 | 8 | Δ | 100 |
| | 9 | 5010 | 1670 | 3 | 9 | ∘ | 100 |
| | 10 | 5010 | 1670 | 3 | 7 | x | 93 |
| | 11 | 6600 | 1100 | 6 | 5 | x | 91 |

It is apparent from the results in table 1 that working examples 1 to 11 exhibited little weft thread untwisting and superior quality of appearance and productivity. In addition, working examples 1 to 11 exhibited no weaving-induced reductions in tensile strength. In other words, fuzz formation on the part of the weft threads was impeded during weaving, yielding superior quality of appearance.

1. A woven fiber reinforcement layer for conveyor belts in which warp threads and weft threads are formed from polyester fibers, the woven fiber reinforcement layer being characterized in that
the weft threads are single-twist threads in which one or multiple filaments are arranged and twisted in a single direction, and twist count T of the weft threads is set according to linear mass density D per single weft thread as follows:
if 840 dtex≦D<2200 dtex, then T is from 8 to 10 (twists/10 cm);
if 2200 dtex≦D<4400 dtex, then T is from 7 to 8 (twists/10 cm); and
if 4400 dtex≦D<6700 dtex, then T is from 6 to 7 (twists/10 cm).

2. The woven fiber reinforcement layer for conveyor belts according to claim 1, wherein the woven fiber reinforcement layer is plain-woven.
